(19) United States
(12) Patent Application Publication
(10) Pub. No.: US 2004/0181584 A1
(43) Pub. Date: Sep. 16, 2004

(54) Method and apparatus for exchanging an attachment in a group communication network

(76) Inventors: Eric Rosen, Solana Beach, CA (US); Ravinder Paul Chandhok, Poway, CA (US); Douglas Crockett, San Diego, CA (US); Jake Levi, San Diego, CA (US); John Purlia, San Diego, CA (US); David Ross, San Diego, CA (US)

Correspondence Address: QUALCOMM Incorporated, Attn: Patent Department, 5775 Morehouse Drive, San Diego, CA, 92121-1714, US

(21) Appl. No.: 10/389,394

(22) Filed: Mar. 14, 2003

(51) Int. Cl. G06F 15/16

(52) U.S. Cl. 709/206; 709/227

(57) ABSTRACT

The disclosed embodiments provide methods and apparatus for exchanging attachments in a wireless communication network. The method includes receiving an indication from a user for sending an attachment to at least one target, and forwarding an alert to the at least one target, wherein the alert includes information about the attachment.

### FIELD

The present invention relates to point to point or point to multi-point communication systems. More specifically, the present invention relates to methods and apparatuses for exchanging attachments via alert messages in a group wireless communication network.

### BACKGROUND

A class of wireless services intended for quick, efficient, one-to-one or one-to-many (group) communication has existed in various forms for many years. In general, these services have been half-duplex, where a user presses a “push-to-talk” (PTT) button on a phone/radio to initiate a group communication. If granted the floor, the talker then generally speaks for a few seconds. After the talker releases the PTT button, other users who are available may request the floor. These services have traditionally been used in applications where one person, a “dispatcher,” needs to communicate with a group of people, such as field service personnel or taxi drivers, which is where the “dispatch” name for the service comes from. Similar services have been offered on the Internet and are generally known as “voice chat.”

There is a need, therefore, for mechanisms to provide a convenient method of exchanging information in a wide range of formats to one or many targets. There is also a need for delivering attachments to a plurality of targets in parallel, using a common user interface and signaling such as a PTT call or PTT alert.

### SUMMARY

The disclosed embodiments provide novel and improved methods and apparatus for exchanging an attachment in a wireless communication network. The method includes receiving an indication from a user for sending an attachment to at least one target, and forwarding an alert to the at least one target, wherein the alert includes information about the attachment.

In another aspect, a method for communicating with a target in a wireless communication network includes forwarding a first alert to at least one target, wherein the first alert includes information requesting the at least one target to respond to the first alert via a second alert. The method further includes receiving the second alert, wherein the second alert includes information about an attachment.

In one aspect, an apparatus for exchanging an attachment in a wireless communication network includes a memory unit, a receiver, a transmitter, and a processor communicatively coupled with the memory unit, the receiver, and the transmitter. The processor is capable of carrying out the above-mentioned methods.

### BRIEF DESCRIPTION OF THE DRAWINGS

The features and advantages of the present invention will become more apparent from the detailed description of the embodiments set forth below:

FIG. 1 illustrates a group communications system;

FIG. 2 illustrates how several communication devices interact with a group communication server;

FIG. 3 illustrates on embodiment for implementing a wireless communications infrastructure;

FIG. 4 illustrates a flow diagram for a process of exchanging attachments; and

FIG. 5 illustrates one embodiment for the group call server operating in FIG. 1.

### DETAILED DESCRIPTION

Before several embodiments are explained in detail, it is to be understood that the scope of the invention should not be limited to the details of the construction and the arrangement of the components set forth in the following description or illustrated in the drawings. Also, it is to be understood that the phraseology and terminology used herein is for the purpose of description and should not be regarded as limiting.

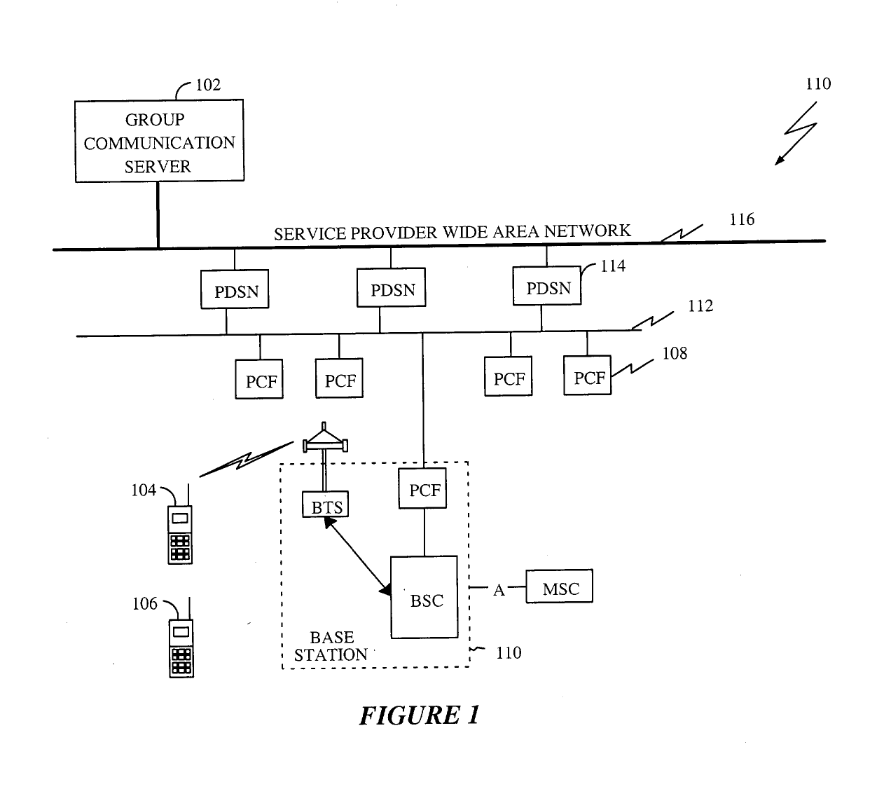

FIG. 1 illustrates a functional block diagram of a group communication system 100, for implementing one embodiment. Group communication system 100 is also known as a push-to-talk (PTT) system, a net broadcast service (NBS), a dispatch system, or a point-to-multi-point communication system. In one embodiment, group communication system 100 includes a group communication server 102, which may be deployed in either a centralized deployment or a regionalized deployment.

Group communication devices (CDs) 104 and 106, which may be deployed such as cdma2000 handset, for example, may request packet data sessions using a data service option. Each CD may use the session to register its Internet Protocol (IP) address with the group communication server to perform group communication initiations. In one embodiment, group communication server 102 is connected to the service provider's packet data service nodes (PDSNs) through service provider's network 116. CDs 104 and 106, upon requesting packet data sessions from the wireless infrastructure, may have IP connectivity to group communication server 102 through the PDSNs 114. Each PDSN may interface to a base station controller (BSC) through a packet control function (PCF) 108 and a network 112. The PCF may be co-located with the BSC within a base station (BS) 110.

A packet data service node may fall in one of several states, e.g., active or connected state, dormant state, and null or inactive state. In the active or connected state, a active traffic channel exists between the participating CD and the BS or BSC, and either side may send data. In the dormant state, no active traffic channel exists between the participating CD and the BSC, but a point-to-point protocol (PPP) link is maintained between the participating CD and the PDSN. In the null or inactive state, there is no active traffic channel between the participating CD and the BSC, and no PPP link is maintained between the participating CD and the PDSN.

After powering up, CDs 104 and 106 may request packet data sessions. As part of establishing a packet data session, each CD may be assigned an IP address. Each CD may perform a registration process to notify group communication server 102 of the CD's IP address. Registration may be performed using an IP protocol, such as session initiation protocol (SIP) over user datagram protocol (UDP). The IP address of a CD may be used to contact the CD when the corresponding user is invited into a group communication.

Once a group communication is established, CDs 104 and 106 and group communication server 102 may exchange media and signaling messages. In one embodiment, media may be exchanged between the participating CDs and the group communication server by using real-time protocol (RTP) over UDP. The signaling messages may also be exchanged by using a signaling protocol over UDP.

Group communication system 100 performs several different functions in order to operate group communication services. The functions that relate to the user side include user registration, group communication initiation, group communication termination, sending alerts to group participants, late join to a group communication, talker arbitration, adding members to a group, removing members from a group, un-registering a member, and authentication. The functions that relate to system preparation and operation include administration and provisioning, scalability, and reliability. These functions are described in detail in the co-pending patent application entitled, “A Communication Device for Defining a Group in a Group Communication Network,” U.S. patent application Ser. No. 10/076,726, filed Feb. 14, 2002, which is assigned to the same assignee and incorporated herein by reference in its entirety.

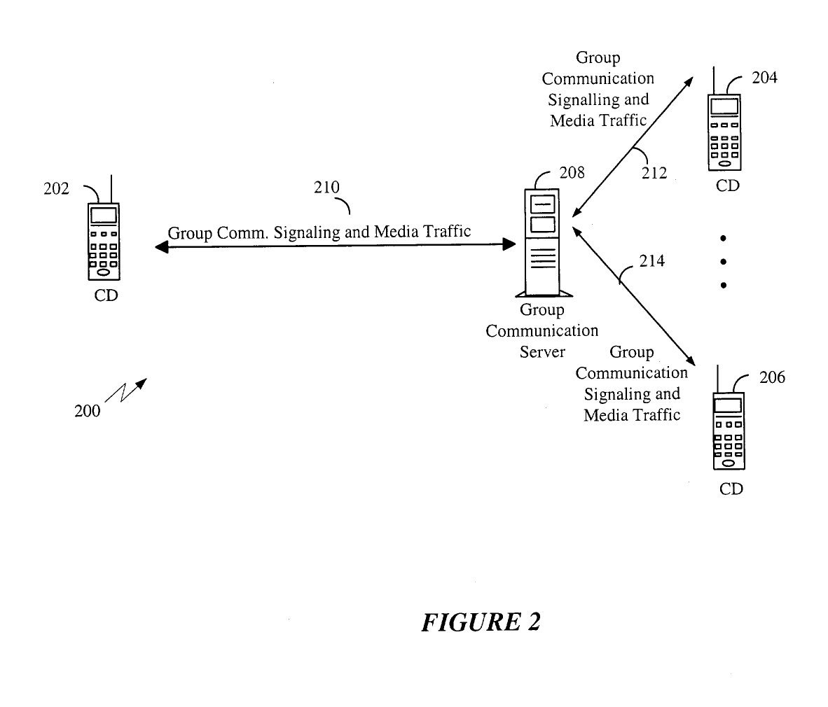

FIG. 2 illustrates a group communication arrangement 200 for showing how CDs 202, 204, and 206 interact with a group communication server 208. Multiple group communication servers may be deployed as desired for large-scale groups. A user may input her desire to a CD 202, 204, 206 to initiate a communication session for exchanging communication media, e.g., data, voice, image, and/or video, with one or more CDs. In one embodiment, the user may first invite the target users(s) before starting to communicate media, by pushing an “invite” or a PTT button on a CD.

In FIG. 2, when CD 202 has permission to transmit media to other members of the group, CD 202 is known as the talker and may transmit media over an established channel. When CD 202 is designated as the talker, the remaining participants, CD 204 and CD 206, may not be permitted to transmit media to the group. Accordingly, CD 204 and CD 206 are designated as listeners. As described above, CDs 202, 204, and 206 are connected to group communication server 208, using at least one channel. In one embodiment, channels 210, 212, and 214 may include a session initiation protocol (SIP) channel, a media-signaling channel, and a media traffic channel.

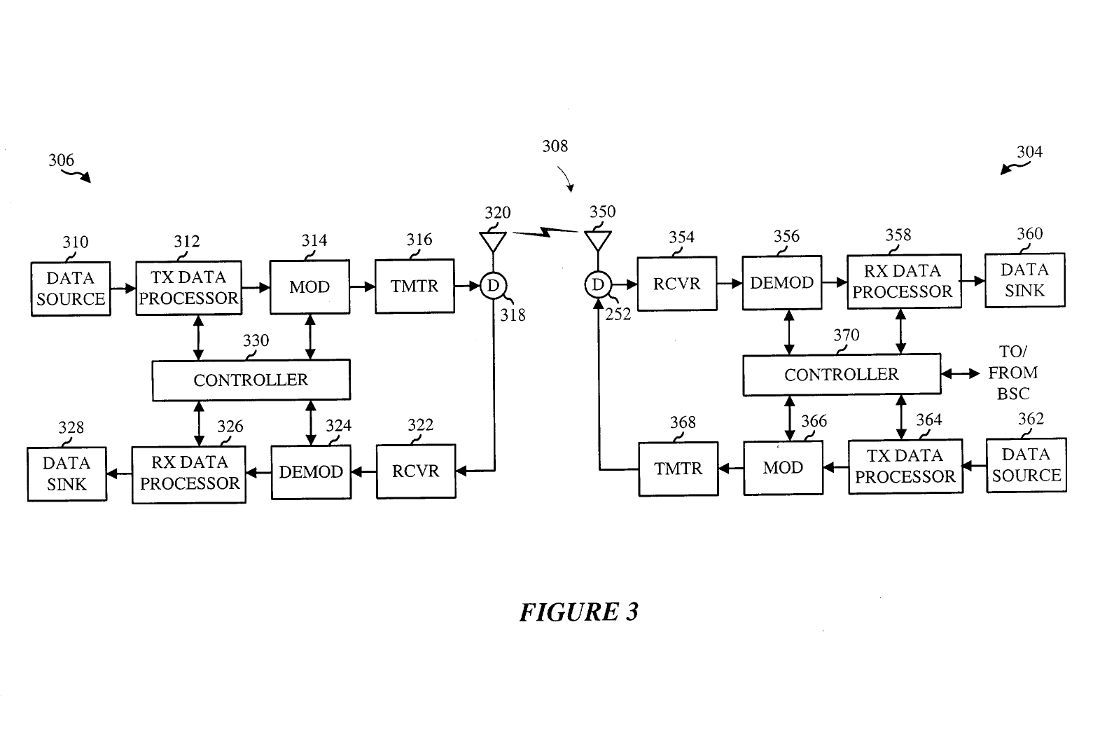

FIG. 3 is a simplified block diagram of an embodiment of a base station/base station controller (BS/BSC) 304 and a communication device 306, which are capable of implementing various disclosed embodiments. For a particular communication, voice, data, packet data, and/or alert messages may be exchanged between BS/BSC 304 and communication device 306, via an air interface 308. Various types of messages may be transmitted, such as messages used to establish a communication session between the base station and the communication device, registration and paging messages, and messages used to control a data transmission (e.g., power control, data rate information, acknowledgment, and so on). Some of these message types are described in further detail below.

For the reverse link, at communication device 306, voice and/or packet data (e.g., from a data source 310) and messages (e.g., from a controller 330) are provided to a transmit (TX) data processor 312, which formats and encodes the data and messages with one or more coding schemes to generate coded data. Each coding scheme may include any combination of cyclic redundancy check (CRC), convolutional, turbo, block, and other coding, or no coding at all. The voice, packet data, and messages may be coded using different schemes, and different types of messages may be coded differently.

The coded data is then provided to a modulator (MOD) 314 and further processed (e.g., covered, spread with short PN sequences, and scrambled with a long PN sequence assigned to the user terminal). The modulated data is then provided to a transmitter unit (TMTR) 316 and conditioned (e.g., converted to one or more analog signals, amplified, filtered, and quadrature modulated) to generate a reverse link signal. The reverse link signal is routed through a duplexer (D) 318 and transmitted via an antenna 320 to BS/BSC 304.

At BS/BSC 304, the reverse link signal is received by an antenna 350, routed through a duplexer 352, and provided to a receiver unit (RCVR) 354. Alternatively, the antenna may be part of the wireless operator network, and the connection between the antenna and the BS/BSC may be routed through the Internet. BS/BSC 304 may receive media information and alert messages from remote access device 306. Receiver unit 354 conditions (e.g., filters, amplifies, down converts, and digitizes) the received signal and provides samples. A demodulator (DEMOD) 356 receives and processes (e.g., despreads, decovers, and pilot demodulates) the samples to provide recovered symbols. Demodulator 356 may implement a rake receiver that processes multiple instances of the received signal and generates combined symbols. A receive (RX) data processor 358 then decodes the symbols to recover the data and messages transmitted on the reverse link. The recovered voice/packet data is provided to a data sink 360 and the recovered messages may be provided to a controller 370. Controller 370 may include instructions for receiving and sending information, receiving and sending alert messages, receiving and sending responses to alert messages, sending information, measuring time between sending an alert message and receiving a response to the alert message, transforming information from one format to another, encrypting and/or decrypting information, and compressing and/or decompressing information. The processing by demodulator 356 and RX data processor 358 are complementary to that performed at remote access device 306. Demodulator 356 and RX data processor 358 may further be operated to process multiple transmissions received via multiple channels, e.g., a reverse fundamental channel (R-FCH) and a reverse supplemental channel (R-SCH). Also, transmissions may be simultaneously from multiple mobile stations, each of which may be transmitting on a reverse fundamental channel, a reverse supplemental channel, or both.

On the forward link, at BS/BSC 304, voice and/or packet data (e.g., from a data source 362) and messages (e.g., from controller 370) are processed (e.g., formatted and encoded) by a transmit (TX) data processor 364, further processed (e.g., covered and spread) by a modulator (MOD) 366, and conditioned (e.g., converted to analog signals, amplified, filtered, and quadrature modulated) by a transmitter unit (TMTR) 368 to generate a forward link signal. The forward link signal is routed through duplexer 352 and transmitted via antenna 350 to remote access device 306. Forward link signals include paging signals.

At communication device 306, the forward link signal is received by antenna 320, routed through duplexer 318, and provided to a receiver unit 322. Receiver unit 322 conditions (e.g., down converts, filters, amplifies, quadrature modulates, and digitizes) the received signal and provides samples. The samples are processed (e.g., despreaded, decovered, and pilot demodulated) by a demodulator 324 to provide symbols, and the symbols are further processed (e.g., decoded and checked) by a receive data processor 326 to recover the data and messages transmitted on the forward link. The recovered data is provided to a data sink 328, and the recovered messages may be provided to controller 330. Controller 330 may include instructions for receiving and sending information, receiving and sending alert messages, receiving and sending responses to alert messages, sending information, measuring time between sending an alert message and receiving a response to the alert message, transforming information from one format to another, encrypting and/or decrypting information, and compressing and/or decompressing information.

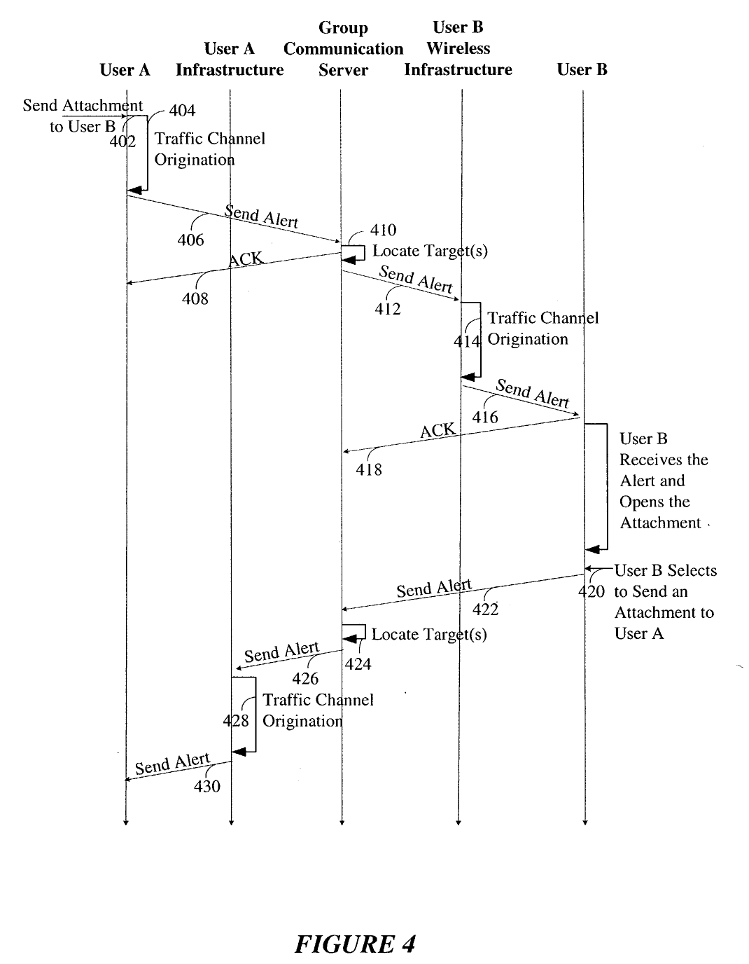

FIG. 4 illustrates a message-flow diagram showing a process for exchanging attachments, according to one embodiment. A user may set up a communication session for communicating information, such as data, text, formatted document, voice, image, and/or video, to a single or a group of target users. The user who wishes to initiate the communication session for sending an attachment may select one or more target users, one or more pre-defined groups of target users, or a combination of the two, and press a button, such as a push-to-talk (PTT) button, on a CD. The user may start delivering information after pressing the PTT button. Alternatively, the user may wait until a communication session is established, as the user's CD may be in a dormant packet data session when the user initiates the communication session.

Alternatively, the user may prefer to first invite the target user(s). After at least one target user has accepted the invitation, the inviter may start sending the attachment. The invitation delivered to the target user(s) may include an expiration time for accepting the invitation. After the expiration time has reached, even if a target user accepts the invitation, no communication session may be established, according to one embodiment. The inviter and/or the invitee(s) may be notified accordingly.

Referring to FIG. 4, after the user A's CD receives an indication for sending an attachment, in step 402, the user A's CD sends an alert message to a server for distribution to the targets. The user A's CD sends the alert message regardless of whether the user A's CD has a dedicated traffic channel established or not, as will be discussed in more detail later herein. In one embodiment, if the user A's CD is in dormant packet data session, the user A's CD causes the process of re-establishing its dedicated traffic channel and prepares the packet data session for media activity, in step 404, before sending the alert message to the server, in step 406. The server may send an “acknowledge” (ACK) message to user A or the user A's CD, in step 408, indicating that the alert message is successfully delivered to the server.

Alternatively, when the user A's CD is in dormant packet data session, the user A's CD may forward the alert message to the server on a common channel, in step 406, without waiting for re-establishing its dedicated traffic channel. The user A's CD may forward the alert message to the server, in step 406, in short data burst (SDB) format, as discussed in more detail in the following.

When the server receives the alert message, the server expands the pre-defined groups of target user(s), if any is specified in the received alert message, into a list of group members. The server retrieves location information for the target invitee(s), in step 410. After the server locates at least one of the targets, the server sends the alert message to the target's wireless infrastructure, in step 412. The attachments may be sent to a plurality of targets in parallel, using a common user interface and signaling such as a PTT call or PTT alert.

The server sends the alert message to a target regardless of whether the target has an established dedicated traffic channel, as will be discussed in more detail later herein. In one embodiment, when the target is in dormant packet data session, the wireless infrastructure causes the process of re-establishing the target's dedicated traffic channel and prepares packet data sessions for media activity, in step 414, before sending the alert message to the target(s), in step 416. When at least one target receives the alert message, the target's CD may send an acknowledge (ACK) message to the sever, in step 418, indicating that the alert message is successfully delivered to at least one of the targets.

Alternatively, when the user B's CD is in dormant packet data session, the server may forward the alert message to the user B's CD on a common channel, in step 416, without waiting for re-establishing a dedicated traffic channel. The server may forward the alert message to the targets' CDs, in step 416, in short data burst (SDB) format, as discussed in more detail in the following. The server may also broadcast the alert message to the targets' CDs, in step 416.

The target user who has received the alert message may open the attachment, if the attachment is included in the alert message, or access the attachment, it the alert message includes a pointer to the attachment. The attachment may include a file or memo located on a server in the network, e.g., the group communication server. The attachment may include a file or memo located on the user A's communication device or on one or more of the targets', e.g., user B, communication devices.

The pointer to the attachment includes a universal resource indicator (URI) pointer. A URI pointer for an attachment residing on a server includes an address part to the hosting server and an attachment identifier. A URI pointer for an attachment residing on a communication device includes an address part to the hosting communication device and an attachment identifier.

The attachment may be exchanged in a wide range of formats to one or many targets. The attachment may include a voice file or memo, which may be implemented as vocoder frame or equivalents. The attachment may include an image file or memo, which may be implemented as picture exchange. The attachment may include a video file or memo, which may be implemented as video file exchange. The attachment may include contact information file or memo, which may be implemented as v-card or equivalent, for sharing address book-type contact information. The attachment may include a coordinated calendaring file or memo, which may be implemented as meeting proposal and/or calendar-type information exchange. The attachment may include coupon, tickets, and the like, which may be implemented as text or a formatted document, e.g., PDF, files.

The alert message also includes a description of the content of the attachment. For example, an audio content may be described by “audio/qcelp,” where qcelp stands for Qualcomm code excitement linear predictor, an image content may be described by “image/jpeg,” and a video content may be described by “video/mp4.” Other equivalent media description and/or standards may also be used.

The alert message or the attachments may include a request or invitation that the recipient target respond by sending an alert message, which may also include an attachment or a pointer to an attachment. When at least one target, who has received the alert message, e.g., user B, selects to reply with an alert message, user B presses a PTT button on her CD to send the alert message, in step 420. The user B's CD sends the alert response, in step 422, to the server on a dedicated channel or a common channel as discussed above. After the server locates the targets' CDs, in step 424, the server may send the alert message to user A's infrastructure, in step 426.

If user A's traffic channel is released, when the alert message is reached at the user A's infrastructure in step 426, the user A's infrastructure initiates the process of re-establishing its dedicated traffic channel and prepares the packet data session for media activity, in step 428, before sending the alert message to the user A's CD, in step 430.

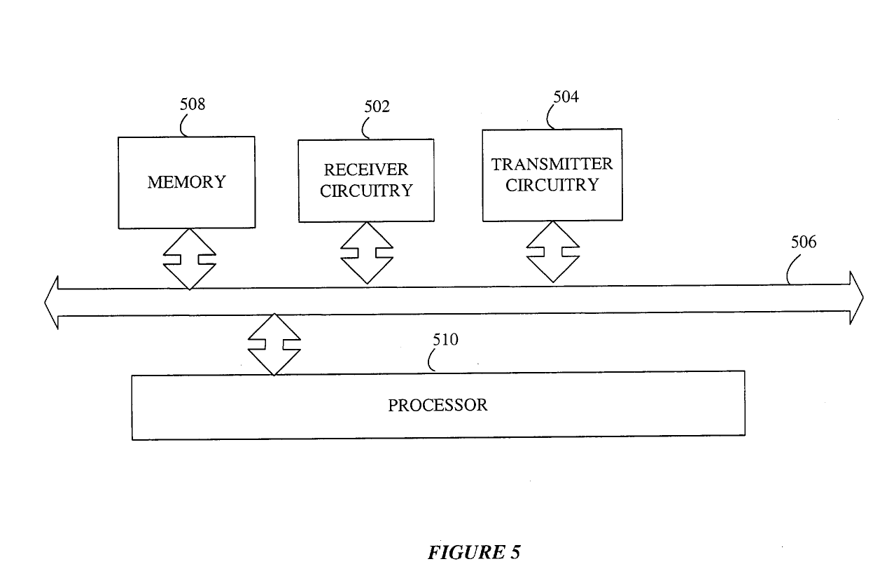

FIG. 5 illustrates one embodiment for the group call server 102 operating in system of FIG. 1. The group call server includes a receiver circuitry 502 and a transmit circuitry 504. Communication bus 506 provides a common connection among other modules in FIG. 6. Communication bus 506 is further coupled to memory unit 508. Memory unit 508 stores computer readable instructions for a variety of operations and functions performed by the group call server. The processor 510 performs the instructions stored in memory unit 508.

In one embodiment, group communication system 100 (FIG. 1) supports both chat-room and ad-hoc models for group communication. In the chat-room model, groups are predefined, which may be stored on the group communication server. The predefined groups, or nets, may be public, implying that the group has an open member list. In this case, each group member is a potential participant in a group communication. The group communication is started when a first group member starts to initiate a group communication. The call remains running for a pre-determined time period, which may be configured by the service provider. During a group communication, the group members may specifically request to join or leave the call. During periods of talk inactivity, the group communication may be brought into a group dormant state until a group member requests permission to talk. When operating in the chat-room model, group members, also known as net members, communicate with one another using a communication device assigned to each net member. The term “net” denotes a group of members authorized to communicate with each other.

In the ad-hoc model of group communication, however, groups may be defined in real-time and have a closed member list associated with each group. A closed member list may specify which members are allowed to participate in the group communication. The member list may not be available to others outside of the closed member list, and may only exist for the life of the call. Ad-hoc group definitions may not be stored in the group communication server. The definitions may be used to establish the group communication and released after the call has ended. An ad-hoc group may be formed when a caller selects one or more target members and generates a group communication request, which is sent to the group communication server to start the call. The group communication server may send a notification to the target group members that they have been included in the group. The group communication server may automatically join the target members into the group communication, i.e., no action may be required from the target members. When an ad-hoc call becomes inactive, the group communication server may “tear down” the call and free the resources assigned to the group, including the group definition used to start the call.

PTT Latency

To reduce PTT latency, the group communication signaling, such as alert messages and/or responses, floor-control requests, floor-control announcements, and dormancy wakeup messages, may be transmitted on some available common channels. This eliminates waiting for dedicated traffic channels to be re-established. Common channels may be always available, regardless of the state of the participating CDs, and may not require being requested and reassigned each time a group member initiates a group communication. Therefore, the group communication signaling messages may be exchanged even when the participating CDs are dormant. In one embodiment dedicated traffic channels for the caller's CD and targets' CDs may be re-established in parallel.

In one embodiment, a dormant user A's CD may send an alert message to the wireless infrastructure over some available reverse common channel, such as reverse access channel and reverse enhanced access channel. The user A's CD may also receive an alert message on some available forward common channel, such as forward paging channel and forward common control channel. In one embodiment, dormant target CDs may receive dormancy wakeup messages and/or alert messages on some available forward common channel, such as forward paging channel and forward common control channel.

Short Data Burst Call-Signaling Messages

In one embodiment, a significant reduction in dormancy wakeup time may be achieved through the use of short data burst (SDB) messages, as provided in “TIA/EIA/IS-2000 Standards for cdma2000 Spread Spectrum Systems,” hereinafter referred to as “the cdma2000 standard.” In one embodiment, SDB messages may be sent over a dedicated active channel, such as the forward fundamental channel (FCH) or forward dedicated common control channel (F-DCCH). SDB messages may also be sent over a common active channel, such as the reverse access channel (R-ACH), reverse enhanced access channel (R-EACH), forward common control channel (F-CCCH), or paging channel (PCH). SDB messages may be transported by radio burst protocol (RBP), which maps the messages onto an appropriate and available active layer channel. Because SDB messages may carry arbitrary IP traffic and may be sent over common active channels, SDB messages provide a mechanism to exchange group communication signaling when participating CDs have no available dedicated traffic channel.

In one embodiment, media-signaling messages may carry IP datagrams over the reverse link or mobile-originated link. A communication device may signal the group communication server quickly whenever a user requests the floor and a dedicated reverse traffic channel is not immediately available. Assuming the CD has released all dedicated traffic channels, the CD may immediately forward the alert message over a reverse common channel of a wireless infrastructure, which may relay the alert message to the group communication server. For example, either the reverse access channel or the reverse enhanced access channel may be used to send such messages when a dedicated reverse channel is not available. In one embodiment, the CD may transmit an alert message to the group communication server as SDB messages.

Those of skill in the art would understand that information and signals may be represented using any of a variety of different technologies and protocols. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The description of the disclosed embodiments is provided to enable any person skilled in the art to make or use the present invention. Various modifications to these embodiments may be readily apparent to those skilled in the art, and the generic principles defined herein may be applied to other embodiments, e.g., in an instant messaging service or any general wireless data communication applications, without departing from the spirit or scope of the invention. Thus, the present invention is not intended to be limited to the embodiments shown herein but is to be accorded the widest scope consistent with the principles and novel features disclosed herein. The word “exemplary” is used exclusively herein to mean “serving as an example, instance, or illustration.” Any embodiment described herein as “exemplary” is not necessarily to be construed as preferred or advantageous over other embodiments.

1. A method for exchanging an attachment in a wireless communication network, the method comprising:
receiving an indication from a user for sending an attachment to at least one target; and
forwarding an alert to the at least one target, the alert including information about the attachment.

2. The method of claim 1, wherein said forwarding includes forwarding in a half-duplex communication session.

3. The method of claim 1, wherein said forwarding the alert includes forwarding the alert on a common channel of a wireless network infrastructure.

4. The method of claim 3, wherein said forwarding the alert includes forwarding the alert as short data bursts.

5. The method of claim 1, wherein the alert includes the attachment.

6. The method of claim 5, wherein the alert includes a pointer to the attachment.

7. The method of claim 6, wherein the attachment includes a file located on a server.

8. The method of claim 6, wherein the attachment includes a file located on the user's communication device.

9. The method of claim 6, wherein the attachment includes a file located on the at least one target's communication device.

10. The method of claim 6, wherein the pointer includes a uniform resource indicator (URI).

11. The method of claim 6, wherein the alert further includes a description of the attachment.

12. The method of claim 1, wherein the attachment includes a voice file.

13. The method of claim 1, wherein the attachment includes an image file.

14. The method of claim 1, wherein the attachment includes a video file.

15. The method of claim 1, wherein the attachment includes a text file.

16. The method of claim 1, wherein the attachment includes a formatted document.

17. The method of claim 1, wherein the attachment includes a coordinated-calendaring file.

18. The method of claim 1, wherein said forwarding includes broadcasting the alert to a plurality of targets.

19. A method for communicating with a target in a wireless communication network, the method comprising:
forwarding a first alert to at least one target, the alert including information requesting the at least one target to respond to the first alert via a second alert, the first alert including information about an attachment; and
receiving the second alert, the second alert including information about an attachment.

20. The method of claim 19, wherein said forwarding includes forwarding in a half-duplex communication session.

21. The method of claim 19, wherein said forwarding includes forwarding on a common channel of a wireless network infrastructure.

22. The method of claim 21, wherein said forwarding includes forwarding the alert as short data bursts.

23. The method of claim 19, wherein at least one of the first alert and the second alert includes the corresponding attachment.

24. The method of claim 19, wherein at least one of the first alert and the second alert includes a pointer to the corresponding attachment.

25. The method of claim 19, wherein at least one of the first alert and the second alert includes a pointer to the corresponding attachment located on a server.

26. The method of claim 19, wherein at least one of the first alert and the second alert includes a pointer to the corresponding attachment located on the user's communication device.

27. The method of claim 19, wherein at least one of the first alert and the second alert includes a pointer to the corresponding attachment located on the at least one target's communication device.

28. The method of claim 24, wherein the pointer includes a uniform resource indicator (URI).

29. The method of claim 24, wherein a least one of the first alert and the second alert includes a description of the corresponding attachment.

30. The method of claim 19, wherein at least one of the attachments includes a voice file.

31. The method of claim 19, wherein at least one of the attachments includes an image file.

32. The method of claim 19, wherein at least one of the attachments includes a video file.

33. The method of claim 1, wherein the attachment includes a text file.

34. The method of claim 19, wherein at least one of the attachments includes a formatted documnet.

35. The method of claim 19, wherein at least one of the attachments includes a coordinated-calendaring file.

36. The method of claim 19, wherein said forwarding includes broadcasting the first alert to a plurality of targets.

37. A computer-readable medium storing program codes for performing a method for exchanging an attachment in a wireless communication network, the method comprising:
receiving an indication from a user for sending an attachment to at least one target; and
forwarding an alert to the at least one target, the alert including information about the attachment.

38. An apparatus for exchanging an attachment in a wireless communication network, comprising:
means for receiving an indication from a user for sending an attachment to at least one target; and
means for forwarding an alert to the at least one target, the alert including information about the attachment.

39. An apparatus for exchanging an attachment in a wireless communication network, comprising:
a memory unit;
a receiver;
a transmitter; and
a processor coupled to the memory unit, the receiver, and the transmitter, the processor being capable of:
receiving an indication from a user for sending an attachment to at least one target; and
forwarding an alert to the at least one target, the alert including information about the attachment.

40. A computer-readable medium storing program codes for performing a method for communicating with a target in a wireless communication network, the method comprising:
forwarding a first alert to at least one target, the alert including information requesting the at least one target to respond to the first alert via a second alert, the first alert including information about an attachment; and
receiving the second alert, the second alert including information about an attachment.

41. An apparatus for communicating with a target in a wireless communication network, comprising:
means for forwarding a first alert to at least one target, the alert including information requesting the at least one target to respond to the first alert via a second alert, the first alert including information about an attachment; and
means for receiving the second alert, the second alert including information about an attachment.

42. An apparatus for communicating with a target in a wireless communication network, comprising:
a memory unit;
a receiver;
a transmitter; and
a processor coupled to the memory unit, the receiver, and the transmitter, the processor being capable of:
forwarding a first alert to at least one target, the alert including information requesting the at least one target to respond to the first alert via a second alert, the first alert including information about an attachment; and
receiving the second alert, the second alert including information about an attachment.
